(19) United States
(12) Patent Application Publication
(10) Pub. No.: US 2024/0362772 A1
(43) Pub. Date: Oct. 31, 2024

(54) DEFECT PROBABILITY ESTIMATION BASED ON CONCEPTS INTERRELATIONS

(71) Applicant: AI QUALISENSE 2021 LTD, Tel Aviv-Yafo (IL)

(72) Inventor: Adam Zrehen, Tel Aviv-Yafo (IL)

(73) Assignee: AI QUALISENSE 2021 LTD, Tel Aviv-Yafo (IL)

(21) Appl. No.: 18/607,381

(22) Filed: Mar. 15, 2024

Related U.S. Application Data
(60) Provisional application No. 63/490,522, filed on Mar. 15, 2023.

(51) Int. Cl. G06T 7/00

(52) U.S. Cl. CPC G06T 7/001

(57) ABSTRACT

A method for defect probability estimation based on relationships with concepts, the method may include (a) obtaining an evaluated patch representation, and (b) determining that the evaluates patch representation is not faulty when at least one of the following occurs: (a) for each RPR of a first number (N1) of RPRs, a similarity between the evaluated patch representation is not lower than the first RPR similarity threshold of the RPR; or (b) for each RPR of a second number (N2) of RPRs, a similarity between the evaluated patch representation is lower than the first RPR similarity threshold and not lower than the second RPR similarity threshold of the RPR.

### BACKGROUND OF THE INVENTION

Manufactures items may be generated by manufacturing process. An imperfect manufacturing process will generate faulty manufactured items and good manufactured items.

Defects introduced by the manufacturing process may not be known in advance or may be difficult to detect without prior knowledge of the expected defects resulting from the process variations.

There is a growing need to provide a method for detecting defects even without prior knowledge of the detects.

There is a growing need to provide a method for accurately detecting defects.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a various data structures;

FIG. 3 illustrates an example of a comparison and a data structures; and

FIG. 4 illustrates a system according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

It has been found that a part of a manufactured item can be regarded as a good not only when the part of the manufactured item part is similar (by at least a first similarity threshold) to a first number (N1) of parts of the manufactured item—but also when the manufactured item part is similar (by at least a second similarity threshold—but less than the first similarity threshold) to a second number (N2) of parts of the manufactured item. The second test was surprisingly found to reduce the classifying of good manufactured image parts as faulty.

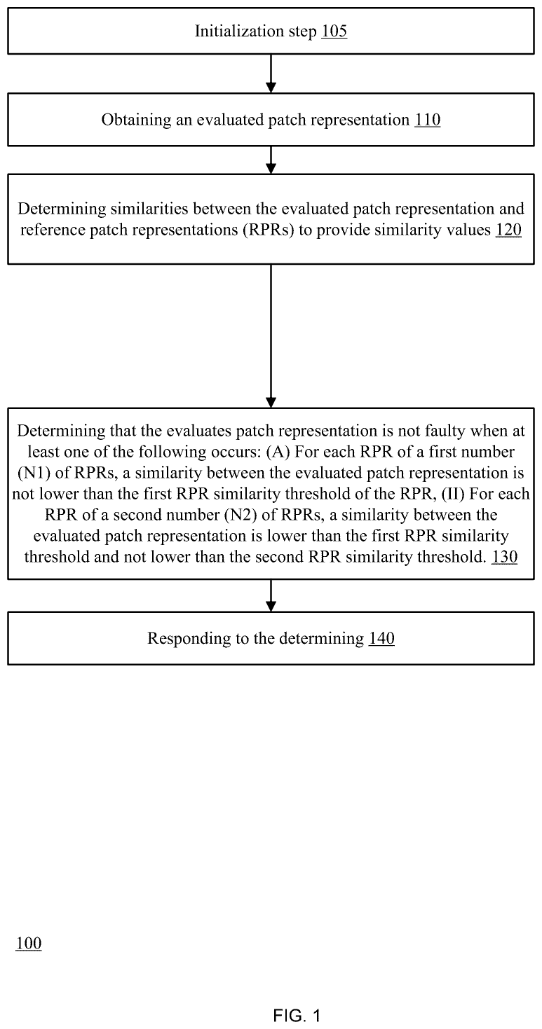

FIG. 1 illustrates an example of method 100 for defect probability estimation based on relationships with concepts.

Method 100 may include initialization step 105 of receiving or determining, reference patch representations (RPRs), and/or for each RPR-receiving or generating a first RPR similarity threshold and a second RPR similarity threshold.

Method 100 may also include step 110 of obtaining an evaluated patch representation.

The evaluated patch representation may be a representation of a patch of an image of an evaluated manufactured item (EMI). In this case step 110 may include obtaining an image of the EMI and segmenting the images to patches (may be evenly sized patches or unevenly sized patches). The segmenting is followed by generating an evaluated patch representation to the patches.

The evaluated patch representation may be a patch of a representation of the image of the EMI. In this case step 110 may include generating a representation of the image and then segmenting the representation of the images to patches.

A representation may be a signature. Examples of signature generations are illustrated in US patent application publication serial number US2020311470A1 which is incorporated herein by reference. The signature may be a list of indexes.

A representation of an EMI may be one or more features (even one or more feature map) generated by of one or more layers of one or more neural network that is fed by (at least) an image of the EMI.

A representation may be a model-such as deep learning model.

Step 110 may be followed by step 120 of determining similarities between the evaluated patch representation and reference patch representations (RPRs) to provide similarity values.

A reference patch representation may be a representation of a patch of an image of a reference manufactured item (RMI). Alternatively, the reference patch representation may be a patch of a representation of an image of the RMI.

Each reference patch representation is associated with a first RPR similarity threshold and with a second RPR similarity threshold. For each RPR, the first RPR similarity threshold exceeds the second RPR similarity threshold. The values of the first and second RPR similarity thresholds may be determined during a training process. The values of the first and second RPR similarity thresholds may represents similarity statistics of RMIs.

Step 120 may be followed by step 130 of determining that the evaluates patch representation is not faulty when at least one of the following occurs:
a. (i) For each RPR of a first number (N1) of RPRs, a similarity between the evaluated patch representation is not lower than the first RPR similarity threshold of the RPR.
b. For each RPR of a second number (N2) of RPRs, a similarity between the evaluated patch representation is lower than the first RPR similarity threshold and not lower than the second RPR similarity threshold.

N1 may equal one or may exceed one. N2 may exceed N1 and may exceed two.

For each RPR, the first RPR similarity threshold and the second RPR similarity thresholds may be indicative of similarities of training patch representations of members of a group of training patch representations associated with the RPR.

For example—first RPR similarity threshold may be set based on a similarity, to the RPR, of a K1'th most similar member of the group of training patch representation, and the second RPR similarity threshold is set based on a similarity, to the RPR, of a K2'th most similar member of the group of training patch representations. K2 exceeds K1. K1 and K2 are positive integers.

K1 and K2 may be different percentiles of a number of members of the group of training patch representations.

The values of K1 and K2 may differ from one RPR to another. The values of K1 and K2 may be determined by a person, by a machine learning process, by a manufacturer of the manufacture items, by a client of the manufacturer, and the like.

The values of one or more of K1, N1, K2 and N2 may be determined to provide a desired relationship (for example ratio—other any other function) between two or more out of true positive, false positive, true negative and false negative values.

The values of one or more of K1, N1, K2 and N2 may be determined, for example, based on an expected percent of functional or non-defective manufactured items. K1 and/or K2 may range between 2-10, 20-50, 40-110, 100-500, and more.

Step 130 may be followed by step 140 of responding to the determining.

The responding may include at least one of generating an indication (for example a message, an alert) regarding the outcome of the determining, transmitting the indication, storing the indication, suggesting to adjust at least one parameter of a manufacturing process, and/or adjusting at least one parameter of a manufacturing process that manufactures manufactured items.

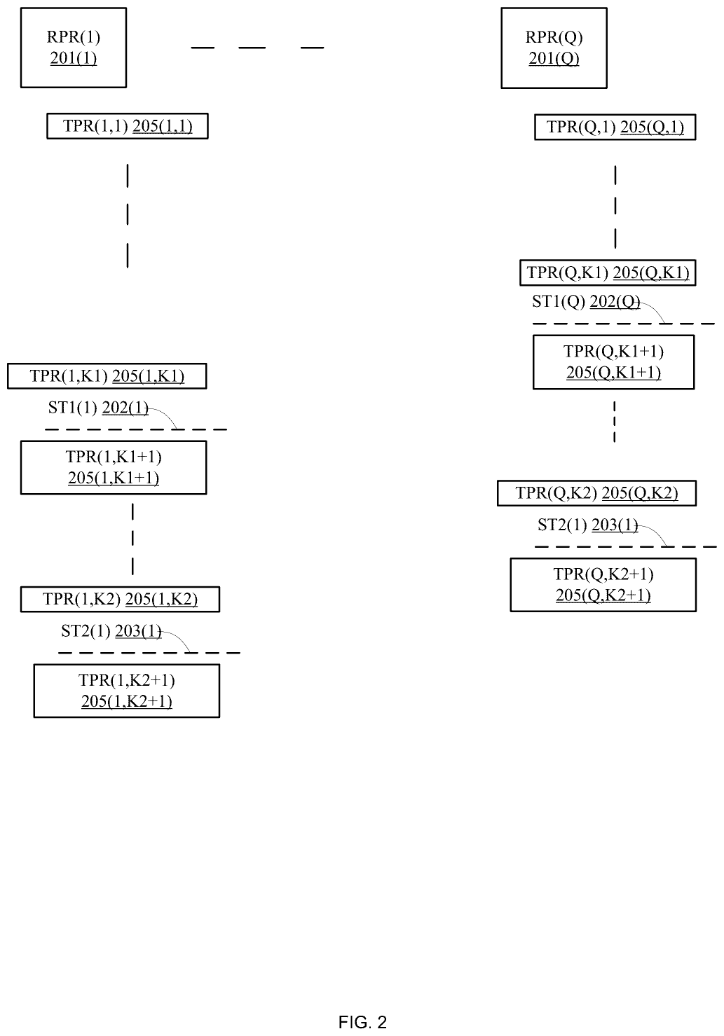

FIG. 2 illustrates an example of multiple (Q) RPRs 201(1)-201(Q), that are associated with first RPR similarity thresholds ST1(1)-ST1(Q) 202(1)-202(Q), and with second RPR similarity thresholds ST2(1)-ST2(Q) 203(1)-203(Q)—a pair of first RPR similarity threshold and second RPR similarity threshold per RPR. FIG. 2 also illustrates an ordered set of training patch representations (generated based on images of training manufactured items)—ordered according to their similarity to each one of the RPRs. the training patches are denoted TPR(i,j) 205(i,j)—wherein index i indicated the relevant RPR and index j indicates the order of similarity.

FIG. 2 also illustrates that the first RPR 201(1) is associated with ST1(1) and ST2(1), and that the Q'th RPR 201(Q) is associated with ST1(Q) and ST2(Q).

The value of ST1(1) is defined to distinguish between the K1'th highest similarity score (between RPR(1) and the K1'th most similar training patch representation) and the (K1+1)'th highest similarity score (between RPR1(1) and the (K1+1)'th most similar training patch representation).

The value of ST1(Q) is defined to distinguish between the K1'th highest similarity score (between RPR(Q) and the K1'th most similar training patch representation) and the (K1+1)'th highest similarity score (between RPR1(Q) and the (K1+1)'th most similar training patch representation).

The value of ST2(1) is defined to distinguish between the K2'th highest similarity score (between RPR(1) and the K2'th most similar training patch representation) and the (K2+1)'th highest similarity score (between RPR(1) and the (K2+1)'th most similar training patch representation).

The value of ST2(Q) is defined to distinguish between the K2'th highest similarity score (between RPR(Q) and the K2'th most similar training patch representation) and the (K2+1)'th highest similarity score (between RPR(Q) and the (K2+1)'th most similar training patch representation).

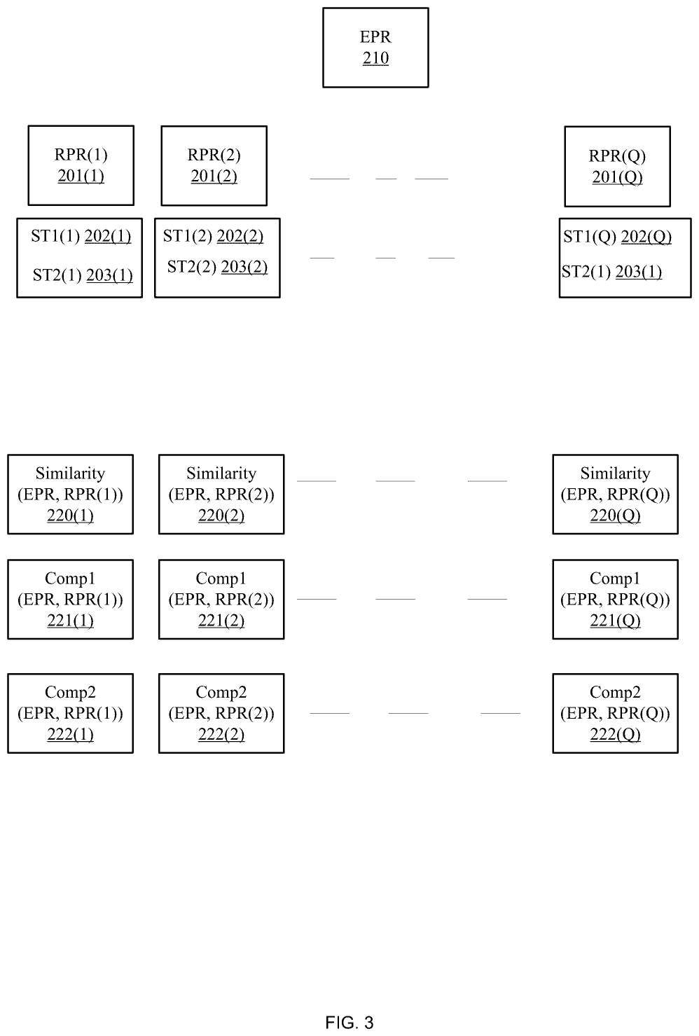

FIG. 3 illustrates an example of an evaluation of an evaluated manufactured item. For simplicity of explanation FIG. 3 will refer to an evaluated patch representation EPR 210 having its similarity compared to the Q RPRs RPR(1)-RPR(Q) 201(1)-201(Q), each having its first RPR similarity threshold and second RPR similarity threshold-ST1(1)-ST1(Q) 202(1)-202(Q) and ST2(1)-ST2(Q) 203(1)-203(Q). The similarities values include Similarity(EPR, PRP(1))-Similarity(EPR, PRP(Q)) 220(1)-22P(Q).

The similarities are compared to the first RPR similarity threshold and second RPR similarity threshold of the Q RPRs to provide Q first comparison results Comp1(EPR, RPR(1))-Comp1(EPR, RPR(Q)) 221(1)-221(Q), and Q second comparison results Comp2 (EPR, RPR(1))-Comp2 (EPR, RPR(Q)) 222(1)-222(Q).

The EPR is deemed good if there are at least N1 first comparison results that indicate that the similarity between EPR and the respective RPR exceed the first RPR similarity thresholds and/or if there are at least N2 second comparison results that indicate that the similarity between EPR and the respective RPR exceed the second RPR similarity thresholds.

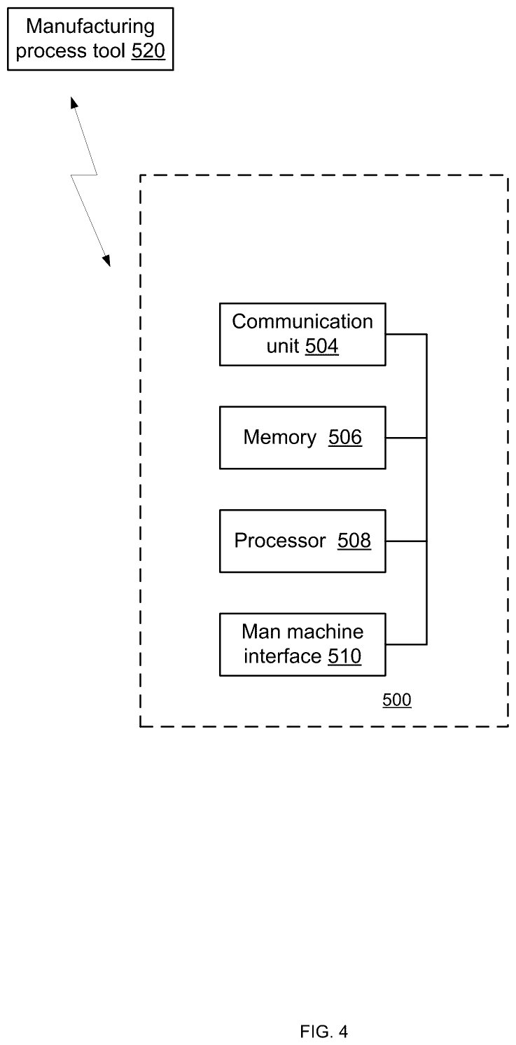

FIG. 4 is an example of a computerized system 500 and a manufacturing process tool 520.

The computerized system 500 may execute method 100.

The computerized system 500 may or may not communicate with the manufacturing process tool 520. It may, for example, provide feedback (for example the process variation alert) about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may include communication unit 504, memory 506, processor 508 and may optionally include a man machine interface 510.

Processor 508 may execute the steps of method 100, Memory 506 is configured to store any data element illustrated in FIG. 2.

Method 100 may be executed by computerized system 500 or by any other computerized system.

Any of the suggested method may be executed by a computerized device that may include one or more processing circuits, memory for storing images and/or anomaly spatial information and/or instructions and/or the outcome of method 100, and a communication unit for communication with other systems and/or devices.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for defect probability estimation based on relationships with concepts, the method comprises:
(a) obtaining an evaluated patch representation; wherein the evaluated patch representation is selected out of (i) a representation of a patch of an image of an evaluated manufactured item (EMI), or (ii) a patch of a representation of the image of the EMI;
(b) determining similarities between the evaluated patch representation and reference patch representations (RPRs) to provide similarity values; wherein each reference patch representation is associated with a first RPR similarity threshold and with a second RPR similarity threshold; wherein for each RPR, the first RPR similarity threshold exceeds the second RPR similarity threshold;
(c) determining that the evaluates patch representation is not faulty when at least one of the following occurs:
a. for each RPR of a first number (N1) of RPRs, a similarity between the evaluated patch representation is not lower than the first RPR similarity threshold of the RPR; or
b. for each RPR of a second number (N2) of RPRs, a similarity between the evaluated patch representation is lower than the first RPR similarity threshold and not lower than the second RPR similarity threshold of the RPR.

2. The method according to claim 1, wherein N1 is smaller than N2.

3. The method according to claim 2, wherein N1 equals one.

4. The method according to claim 3, wherein N2 exceeds two.

5. The method according to claim 1, wherein for each RPR, the first RPR similarity threshold and the second RPR similarity thresholds are indicative of similarities of training patch representations of members of a group of training patch representations associated with the RPR.

6. The method according to claim 5, wherein the first RPR similarity threshold is set based on a similarity, to the RPR, of a K1'th most similar member of the group of training patch representation, and wherein the second RPR similarity threshold is set based on a similarity, to the RPR, of a K2'th most similar member of the group of training patch representations, wherein K2 exceeds K1 and wherein K1 and K2 are positive integers.

7. The method according to claim 6 wherein K1 and K2 are different percentiles of a number of members of the group of training patch representations.

8. The method according to claim 1, comprising determining, for each RPR, the first RPR similarity threshold and the second RPR similarity thresholds.

9. The method according to claim 1 comprising responding to the determining.

10. The method according to claim 9 wherein the responding comprises adjusting at least one parameter of a manufacturing process that manufactures manufactured items.

11. The method according to claim 1 comprising capturing by an image sensor, the image of the EMI.

12. A non-transitory computer readable medium for defect probability estimation based on relationships with concepts, the non-transitory computer readable medium storage instructions that cause a processor to:
(a) obtain an evaluated patch representation; wherein the evaluated patch representation is selected out of (i) a representation of a patch of an image of an evaluated manufactured item (EMI), or (i) a patch of a representation of the image of the EMI;
(b) determine similarities between the evaluated patch representation and reference patch representations (RPRs) to provide similarity values; wherein each reference patch representation is associated with a first RPR similarity threshold and with a second RPR similarity threshold; wherein for each RPR, the first RPR similarity threshold exceeds the second RPR similarity threshold;
(c) determine that the evaluates patch representation is not faulty when at least one of the following occurs:
a. for each RPR of a first number (N1) of RPRs, a similarity between the evaluated patch representation is not lower than the first RPR similarity threshold of the RPR; or
b. for each RPR of a second number (N2) of RPRs, a similarity between the evaluated patch representation is lower than the first RPR similarity threshold and not lower than the second RPR similarity threshold of the RPR.

13. The method according to claim 12, wherein N1 is smaller than N2.

14. The method according to claim 13, wherein N1 equals one.

15. The method according to claim 14, wherein N2 exceeds two.

16. The method according to claim 12, wherein for each RPR, the first RPR similarity threshold and the second RPR similarity thresholds are indicative of similarities of training patch representations of members of a group of training patch representations associated with the RPR.

17. The method according to claim 16, wherein the first RPR similarity threshold is set based on a similarity, to the RPR, of a K1'th most similar member of the group of training patch representation, and wherein the second RPR similarity threshold is set based on a similarity, to the RPR, of a K2'th most similar member of the group of training patch representations, wherein K2 exceeds K1 and wherein K1 and K2 are positive integers.

18. The method according to claim 17, wherein K1 and K2 are different percentiles of a number of members of the group of training patch representations.

19. The method according to claim 12, comprising determining, for each RPR, the first RPR similarity threshold and the second RPR similarity thresholds.

20. The method according to claim 12, comprising responding to the determining.
